(19) United States
(12) Patent Application Publication
(10) Pub. No.: US 2025/0276758 A1
(43) Pub. Date: Sep. 4, 2025

(54) FRAME AND BICYCLE

(71) Applicant: DAHON TECH (SHENZHEN ) CO., LTD., Shenzhen (CN)

(72) Inventors: David Tak Wei Hon, Shenzhen (CN); Huasong Ou, Shenzhen (CN)

(73) Assignee: DAHON TECH (SHENZHEN ) CO., LTD., Shenzhen (CN)

(21) Appl. No.: 19/191,736

(22) Filed: Apr. 28, 2025

(30) Foreign Application Priority Data
Feb. 29, 2024 (CN) 202420392203.9

(51) Int. Cl. B62K 3/02; B62L 1/00

(52) U.S. Cl. CPC B62K 3/02; B62L 1/00

(57) ABSTRACT

This application relates to a frame and a bicycle. The frame includes a seat stay. The seat stay includes a seat stay head portion and a seat stay branch portion. The seat stay branch portion includes a transition segment and an arc-shaped connection segment that are adjacently arranged in a front-rear direction of the frame. The transition segment is adjacently arranged to the seat stay head portion. A length of the seat stay branch portion accounts for more than 25% of a total length of the seat stay. A minimum longitudinal dimension L1 of the arc-shaped connection segment is more than 1.5 times the minimum longitudinal dimension L1 of the transition segment.

### CROSS-REFERENCE TO RELATED APPLICATION

This application claims the benefits of Chinese patent No. 202420392203.9, filed on Feb. 29, 2024, in the China National Intellectual Property Administration, the entire disclosure of which is incorporated herein by reference for all purpose.

### TECHNICAL FIELD

The present disclosure relates to the technical field of bicycle, particular to a frame and a bicycle.

### BACKGROUND

Bicycle, also known as a bike, is generally used as a two-wheeled land vehicle. The bicycle serves not only as an eco-friendly means of transportation for commuting and travelling, but also functions as fitness equipment for cycling exercises and outings. It has become an important tool in people's daily lives for both mobility and fitness purposes.

The bicycle usually includes a seat stay, which is used to mount the rear wheel. In actual use, the seat stay is usually subjected to up and down stress. At present, the seat stay adopts a circular tube structure. The seat stay having such structure is not rigid enough, and can be deformed easily when stressed, which is not conducive to the stability of the bicycle structure.

### SUMMARY

Accordingly, it is necessary to provide a frame and a bicycle to address the technical problem that seat stays lack sufficient rigidity and strength, making them prone to being deformed.

A frame is provided, including a seat stay. The seat stay includes a seat stay head portion and a seat stay branch portion. The seat stay branch portion includes a transition segment and an arc-shaped connection segment that are adjacently disposed in a front-rear direction of the frame, and the transition segment and the seat stay head portion is adjacently disposed.

A minimum longitudinal dimension of the arc-shaped connection segment is more than 1.5 times of a minimum longitudinal dimension of the transition segment, and a length of the seat stay branch portion accounts for more than 25% of a total length of the seat stay.

A longitudinal dimension refers to, in any cross-section perpendicular to an extending direction of the seat stay, a dimension of a cross-section in a longitudinal direction thereof, and a longitudinal direction of the cross-section is perpendicular to an orthographic projection of a left-right direction of the frame on the cross-section.

In some embodiments, a longitudinal dimension of the arc-shaped connection segment gradually increases from an end thereof adjacent to the transition segment to another end thereof.

In some embodiments, in any cross-section of the arc-shaped connection segment, a transverse dimension of the arc-shaped connection segment is less than the longitudinal dimension of the arc-shaped connection segment. The transverse dimension refers to a dimension of the cross-section in a transverse direction thereof, and the transverse direction of the cross-section is consistent with the orthographic projection of the left-right direction of the frame on the cross-section.

In some embodiments, the longitudinal dimension of the transition segment gradually increases from an end thereof adjacent to the seat stay head portion to another end thereof adjacent to the arc-shaped connection segment.

In some embodiments, a transverse dimension of the seat stay branch portion gradually decreases from an end thereof adjacent to the seat stay head portion to another end thereof.

In some embodiments, a longitudinal dimension of the seat stay head portion is less than a transverse dimension of the seat stay head portion.

In some embodiments, the frame further includes a top tube, a seat tube, a bottom bracket, a chain stay, and two rear dropouts. The seat tube is connected to the top tube and the seat stay head portion. The bottom bracket is connected to the seat tube and the chain stay. Each rear dropout is connected to the arc-shaped connection segment and the chain stay. The arc-shaped connection segment is arched away from the chain stay.

In some embodiments, the chain stay includes a chain stay head portion and two chain stay branch portions. The chain stay head portion is connected between the two chain stay branch portions and the bottom bracket. Each chain stay branch portion is independently connected to the arc-shaped connection segment of one seat stay branch portion through the rear dropout. A longitudinal dimension of each chain stay branch portion is greater than a transverse dimension of the chain stay branch portion. Both the longitudinal dimension and transverse dimension of the chain stay branch portion gradually decreases from an end thereof adjacent to the bottom bracket to another end thereof.

In some embodiments, at least one of the chain stay branch portions is provided with a disc-brake mounting portion disposed adjacent to the rear dropout.

An inner wall surface of the at least one of the chain stay branch portions facing another one of the chain stay branch portions is provided with an avoiding recess. The avoiding recess is arranged on an end of the chain stay branch portion adjacent to the chain stay head portion.

In some embodiments, the top tube includes a first top tube segment, a folding mechanism, and a second top tube segment. The second top tube segment is connected to the seat tube. The first top tube segment is hinged to the second top tube segment via the folding mechanism. The folding mechanism allows the first top tube segment to be switched between an unfolded state relative to the second top tube segment and a folded state relative to the second top tube segment.

The frame further includes a tension cable. One end of the tension cable is connected to the bottom bracket and another end of the tension cable is connected to the first top tube segment.

A bicycle is provided, including the frame of above embodiments.

According to above-mentioned frame and bicycle, since the arc-shaped connection segment is adjacent to the rear dropout, it can be subject to greater vertical pressure. Since the arc-shaped connection segment has a relatively large longitudinal dimension, the ability of the arc-shaped connection segment to resist the vertical deformation is greater than the ability of the transition segment to resist the vertical deformation. That is, the rigidity and strength of the arc-shaped connection segment are enhanced, which is conducive to improving the rigidity and strength of the seat stay, so as to improve the ability of the seat stay to resist the vertical deformation, thereby facilitating to improve the stability of the bicycle.

In addition, the arc-shaped connection segment is configured in an arc shape, and a larger accommodation space can be formed between the arc-shaped connection segment and the chain stay, so as to facilitate the mounting of structures such as a disc brake. Furthermore, since the arc-shaped connection segment arches upward, it has a strong ability to resist vertical bending, which can further improve the ability of the seat stay to resist the vertical bending, thereby further enhancing the rigidity and strength of the seat stay.

Moreover, when a length the seat stay branch portion accounts for more than 25% of a total length of the seat stay, the volume of the seat stay is effectively saved. The material consumption for the seat stay is reduced and the cost of the frame is lowered.

### BRIEF DESCRIPTION OF THE DRAWINGS

The above and other objects and features of the present invention will become apparent and more readily appreciated from the following description of the embodiments with reference to the following figures, wherein like reference numerals refer to like parts throughout the various figures unless otherwise specified, and wherein:

FIG. 1 is a schematic perspective view of a frame according to some embodiments of the present application.

FIG. 2 is a front view of the frame shown in FIG. 1.

FIG. 3 is a top view of the frame shown in FIG. 1.

FIG. 4 is a right-side view of the frame shown in FIG. 1.

FIG. 5 is a schematic perspective view of a frame according to other embodiments of the present application.

Reference numerals in the detailed description are as follows:

frame 100, top tube 10, first top tube segment 11, second top tube segment 12, folding mechanism 13, seat tube 20, bottom bracket 30, chain stay 40, chain stay head 41, chain stay branch 42, disc-brake mounting portion 42a, avoiding recess 42b, seat stay 50, seat stay head portion 51, seat stay branch portion 52, transition segment 52a, arc-shaped connection segment 52b, longitudinal dimension L1, transverse dimension L2, rear dropout 60, tension cable 70, head tube member 80, reinforcing tube 90.

### DETAILED DESCRIPTION

In order to facilitate understanding of the present disclosure and to clarify the above-mentioned objects, features, and advantages of the present disclosure, specific embodiments of the present disclosure are described in detail below in conjunction with the accompanying drawings. In the following description, many specific details are provided to facilitate full understanding of the present disclosure. Preferred embodiments of the present disclosure are illustrated by means of the accompanying drawings. However, the present disclosure can be implemented in various forms and is not limited to the embodiments described herein. On the contrary, these embodiments are merely provided to facilitate thorough and comprehensive understanding of the content of the present disclosure. The present disclosure can be implemented in various manners other than those described herein, and similar improvements can be made by those skilled in the art without contradicting the intent of the present disclosure. Therefore, the present disclosure is not limited by specific embodiments disclosed below.

It should be understood that, in the description of the present application, an orientational or positional relationship, if indicated with terms such as “central”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, “anticlockwise”, “axial”, “radial”, or “circumferential”, is an indicated orientational or positional relationship based on the drawings. The orientational or positional relationship shown in the drawing is intended only to facilitate and simplify the description of the present application, but not to indicate or imply that a device or an element referred to must have a specific orientation, or to be constructed and operated in a specific orientation. Thus, it should not be construed as a limitation of the present application.

In addition, the term “first” or “second” is only for descriptive purposes, and it cannot be indicating or implying relative importance or implicitly indicating the number of indicated technical features. Therefore, the features defined with “first” or “second” can explicitly or implicitly include at least one of the features. In the description of the present disclosure, “plurality of” means at least two, unless otherwise specifically indicated. In the present disclosure, “a number of” means at least one, unless otherwise specifically indicated.

In the present application, unless otherwise expressly defined or limited, if terms such as “mounting”, “connecting with”, “connecting to”, “fixed to” should be understood in a broad sense. For example, it may be a fixed connection, a detachable connection, or integrated as a whole. It may be a mechanical connection or an electrical connection. It may be a direct connection, an indirect connection through an intermediate medium, or a connection within two components or an interaction relationship between two components, unless otherwise explicitly defined. For an ordinary person skilled in the art, the specific meaning of the above terms in the present application may be understood according to specific circumstances.

In the present application, unless otherwise explicitly defined or limited, a first feature is “above” or “below” a second feature may mean direct contact between the first and second features, or indirect contact between the first and second features through an intermediate medium. Furthermore, the first feature being “over”, “above”, or “on top of” the second feature means that the first feature may be directly over or obliquely above the second feature, or simply indicates that the level height of the first feature is greater than the second feature. The first feature being “under”, “below”, or “beneath” of the second feature may mean that the first feature is directly below or obliquely under the second feature, or simply indicate that the level height of the first feature is lower than the second feature.

It should be noted that if an element is limited as “fixed on” or “arranged on” another element, it means that the element may be directly on the other element or there exists an intermediate element simultaneously. Terms “perpendicular”, “horizontal”, “up”, “down”, “left”, “right”, and similar expressions used herein are intended merely to descriptive purposes, and not to the only implementation.

A seat stay is provided in an embodiment of the present application to address the problem of low rigidity and strength of conventional seat stays. This seat stay can be applied to a frame.

It should be understood that, a left-right direction, a front-rear direction, and an up-down direction of the frame involved in an embodiment of the present application refer to directions determined with reference to a perspective of a rider in a case where the bicycle is in use. The left-right direction of the frame is a left-right direction of the rider, the front-rear direction of the frame is a front-rear direction of the rider, and the up-down direction of the frame is an up-down direction of the rider.

Furthermore, a longitudinal dimension and a transverse dimension of the seat stay involved in an embodiment of the present application means that on a cross-section perpendicular to an extending direction of the seat stay, an orthographic projection of the left-right direction of the frame on the cross-section is a transverse direction of the cross-section, and a direction perpendicular to the transverse direction is a longitudinal direction of the cross-section. A longitudinal dimension of the cross-section refers to a dimension of the cross-section in its longitudinal direction, and a transverse dimension of the cross-section refers to a dimension of the cross-section in its transverse direction.

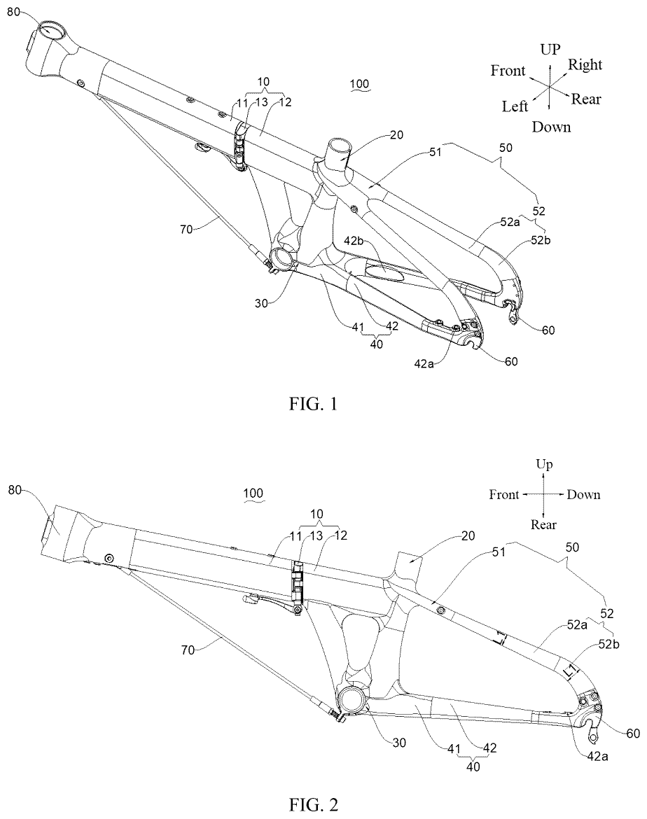

Referring to FIGS. 1 to 4, according to some embodiments of the present application, a frame 100 in an embodiment of the present application includes a seat stay 50. The seat stay 50 includes a seat stay head portion 51 and a seat stay branch portion 52. The seat stay branch portion 52 includes a transition segment 52a and an arc-shaped connection segment 52b, which are adjacently disposed to each other in a front-rear direction of the frame 100. The transition segment 52a is adjacently disposed to the seat stay head portion 51. A minimum longitudinal dimension L1 of the arc-shaped connection segment 52b is 1.5 times more than a minimum longitudinal dimension L1 of the transition segment 52a. A length of the seat stay branch portion 52 accounts for more than 25% of a total length of the seat stay 50. The longitudinal dimension L1 refers to a dimension of a cross-section along its longitudinal direction on any cross-section of the seat stay 50 perpendicular to the extending direction thereof. The longitudinal direction of the cross-section is perpendicular to the orthogonal projection of the frame 100 in the horizontal direction.

Generally, the frame 100 includes a top tube 10, a seat tube 20, a bottom bracket 30, a chain stay 40, two rear dropouts 60, and the seat stay 50. The seat tube 20 is connected to the top tube 10 and the seat stay 50. The bottom bracket 30 is connected to the seat tube 20 and the chain stay 40, and the rear dropouts 60 are connected to the seat stay 50 and the chain stay 40.

The top tube 10, seat tube 20, bottom bracket 30, seat stay 50, chain stay 40, and rear dropouts 60 are integrally connected or welded as a whole. The top tube 10 is connected in front of the seat tube 20 and is configured to be connected to the head tube member 80, which is configured to be mounted with a front end. The seat tube 20 usually extends vertically straight or with an inclined angle. An upper end of the seat tube 20 is generally configured to be mounted with a bicycle seat, and a lower end thereof is connected to the bottom bracket 30. The bottom bracket 30 is configured to be mounted with structures such as foot pedals and it is generally a hollow structure. The bottom bracket 30 is generally located below the top tube 10. The chain stay 40 is connected to the seat tube 20 through the bottom bracket 30. The seat stay 50 is directly connected to the seat tube 20. The bottom bracket 30 may be but not limited to be connected to the top tube 10. The rear dropouts 60 are configured to be mounted with a rear axle. The seat stay 50 and the chain stay 40 are connected through the rear dropouts 60. A specific structure of the rear dropouts 60 is not specified here, and a person skilled in the art may configure it conventionally. It is to be understood that, the seat stay 50 is arranged above the chain stay 40.

Specifically, the seat stay head portion 51 is connected to the seat tube 20. The arc-shaped connection segment 52b is connected to a rear dropout 60. The arc-shaped connection segment 52b arches away from the chain stay 40. The seat stay head portion 51, transition segment 52a, and arc-shaped connection segment 52b are usually, but not limited to, integrally formed as a whole.

Generally, the seat stay 50 include two seat stay branch portions 52, which are spaced apart in the left-right direction of the frame 100 and are both connected to the seat stay head portion 51. Each seat stay branch portion 52 can be independently connected to one rear dropout 60.

The transition segment 52a generally extends substantially in a straight line. The arc-shaped connection segment 52b extends in an arc shape, and the arc-shaped connection segment 52b arches away from the chain stay 40, that is, it arches upwards.

A longitudinal dimension L1 of the transition segment 52a refers to a dimension of each cross-section of the transition segment 52a in a longitudinal direction thereof. Since the transition segment 52a is generally extending in a straight line, the cross-sections of the transition segment 52a are parallel to each other in longitudinal directions thereof. A longitudinal dimension L1 of the arc-shaped connection segment 52b refers to a dimension of a cross-section thereof in its own longitudinal direction. Since the arc-shaped connection segment 52b extends in an arc shape, the cross-sections of the arc-shaped connection segment 52b are not parallel in longitudinal directions thereof.

The minimum longitudinal dimension L1 of the transition segment 52a is the smallest value of longitudinal dimensions of all cross-sections thereof. The minimum longitudinal dimension L1 of the arc-shaped connection segment 52b is the smallest value of longitudinal dimensions of all cross-sections thereof. In an embodiment of the present application, the minimum longitudinal dimension L1 of the arc-shaped connection segment 52b is 1.5 times more than that of the transition segment 52a, that is, the minimum longitudinal dimension L1 of the arc-shaped connection segment 52b is 1.5 times greater than that of the transition segment 52a, or in other words, a portion where the minimum longitudinal dimension L1 of the arc-shaped connection segment 52b exceeds the minimum longitudinal dimension L1 of the transition segment 52a is more than 50% of the minimum longitudinal dimension L1 of the transition segment 52a. Specifically, the minimum longitudinal dimension L1 of the arc-shaped connection section 52b is more than the minimum longitudinal dimension L1 of the transition section 52a by multiples such as 1.5 times, 1.6 times, 1.8 times, 2 times, 2.5 times.

A size of the longitudinal dimension L1 affects an ability of the arc-shaped connection segment 52b and the transition segment 52a to resist vertical deformation. The larger the longitudinal dimension L1 is, the stronger the ability to resist the vertical deformation. Since the arc-shaped connection segment 52b is adjacent to the rear dropout 60, it can be subject to greater vertical pressure. Meanwhile, the ability of the arc-shaped connection segment 52b to resist the vertical deformation is better than that of the transition segment 52a. That is, rigidity and strength of the arc-shaped connection segment 52b are enhanced, which helps to improve the rigidity and strength of the seat stay 50. This further enhances the ability of the seat stay 50 to resist the vertical deformation, which is conducive to the stability of a bicycle structure.

In addition, the arc-shaped connection segment 52b is configured in an arc shape, and a larger accommodation space can be formed between the arc-shaped connection segment 52b and the chain stay 40, so as to facilitate the mounting of a structure such as a disc brake. Furthermore, the arc-shaped connection arches upwards, which has a strong ability to resist vertical bending, enhancing an ability of bending resistance of the seat stay 50, thereby further enhancing the rigidity and strength of the seat stay 50.

The total length of the seat stay 50 refers to a length of a connecting line that connects geometric centers of respective cross-sections of the seat stay 50, which includes a length of the seat stay head portion 51 and a length of the seat stay branch portion 52. The length of the seat stay branch portion 52 includes a length of the transition segment 52a and a length of the arc-shaped connection segment 52b. The length of the seat stay branch portion 52 is more than 25% of the total length of the seat stay 50, that is, the length of the seat stay branch portion 52 is greater than 25% of the total length of the seat stay 50. Specifically, the length of the seat stay branch portion 52 is a certain proportion of the total length of the seat stay 50, such as 30%, 40%, 50%, 60%, 70%, 80%, 90%.

When a proportion of the length of the seat stay branch portion 52 is within the above ranges, a volume of the seat stay 50 can be saved, and the material consumption of the seat stay 50 is reduced, thereby reducing a cost of the frame 100.

In some embodiments, the longitudinal dimension L1 of the arc-shaped connection segment 52b gradually increases from an end of the arc-shaped connection segment 52b adjacent to the transition segment 52a to the other end thereof. That is, the longitudinal dimension L1 of the arc-shaped connection segment 52b gradually increases from front to rear. The minimum longitudinal dimension L1 of the arc-shaped connection segment 52b is located at an interface position between the arc-shaped connection section 52b and the transition segment 52a. A maximum longitudinal dimension L1 of the arc-shaped connection segment 52b is located at an interface position between the arc-shaped connection section 52b and the rear dropout 60.

Meanwhile, the longitudinal dimension L1 of the arc-shaped connection segment 52b continuously increases. The closer it is to the rear dropout 60, the stronger the rigidity and strength of the arc-shaped connection segment 52b, which is conducive to improving the ability of deformation resistance of the seat stay 50 and also helps to save materials.

In some embodiments, in any cross-section of the arc-shaped connection segment 52b, a transverse dimension L2 of the arc-shaped connection segment 52b is less than a longitudinal dimension L1 thereof. The transverse dimension L2 refers to a dimension of the cross-section in a transverse direction thereof. The transverse direction of the cross-section is consistent with an orthographic projection of the left-right direction of the frame 100 on the cross-section.

That is, the transverse dimension L2 of the arc-shaped connection segment 52b is a dimension in the transverse direction of a corresponding cross-section. The transverse direction of the cross-section is perpendicular to the longitudinal direction thereof.

Since transverse dimensions L2 of the arc-shaped connection segment 52b in respective cross-sections are less than longitudinal dimensions L1 thereof, the longitudinal dimensions L1 of the arc-shaped connection segment 52b are greater than the transverse dimensions L2 thereof, such that the arc-shaped connection segment 52b is substantially configured in a flattened shape in the left-right direction of the frame 100. As such, while enhancing the ability of the arc-shaped connection segment 52b to resist vertical deformation, the material consumption is also saved.

In some embodiments, referring to FIG. 2, the longitudinal dimension L1 of the transition segment 52a gradually increases from an end thereof adjacent to the seat stay head portion 51 to an end thereof adjacent to the arc-shaped connection segment 52b. That is, the longitudinal dimension L1 of the transition section 52a increases as it approaches the arc-shaped connecting section 52b. The transition segment 52a is constructed with one end larger and the other end smaller, and the longitudinal dimension of an end becomes larger as it gets closer to the rear dropout 60. In this way, an ability of a rear end of the transition segment 52a to resist vertical deformation is stronger, which is conducive to improving the rigidity and strength of the seat stay 50. Moreover, a front end of the transition segment 52a is relatively thin, which further reduces the material consumption.

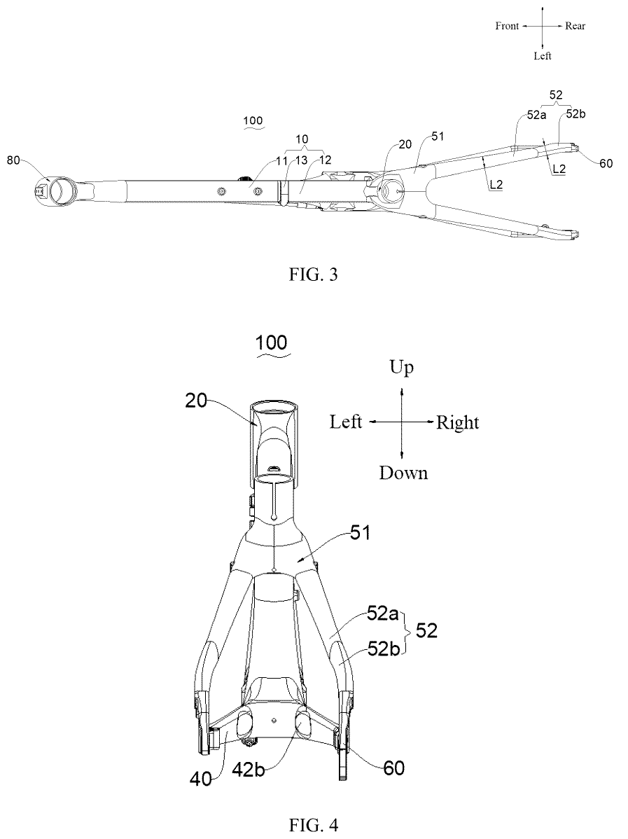

In some embodiments, referring to FIG. 3, a transverse dimension L2 of the seat stay branch portion 52 gradually decreases from an end thereof adjacent to the seat stay head portion 51 to the other end thereof. Meanwhile, the transverse dimension L2 of the seat stay branch portion 52 gradually tapers from front to rear. This is conducive to saving the material consumption and reducing of a space occupied by the seat stay 50, and providing more mounting space for a disc brake, a wheel, etc.

In some embodiments, a longitudinal dimension L1 of the seat stay head portion 51 is less than its transverse dimension L2. In this way, the seat stay head portion 51 is constructed as a substantially vertically flat structure, which is conducive to saving material consumption of the seat stay head portion 51.

In addition, referring to FIGS. 1 to 4, in some embodiments, the frame 100 of the present application further includes a top tube 10, a seat tube 20, a bottom bracket 30, a chain stay 40, a rear dropout 60, and the seat stay 50 of any of the above embodiments. The seat tube 20 is connected to the top tube 10 and the seat stay head portion 51. The bottom bracket 30 is connected to the seat tube 20 and the chain stay 40. The rear dropout 60 is connected to the arc-shaped connection segment 52b and the chain stay 40. The arc-shaped connection segment 52b arches away from the chain stay 40. The frame 100 has all beneficial effects of the above embodiments.

In some embodiments, referring to FIGS. 1 and 2, the chain stay 40 includes a chain stay head portion 41 and two chain stay branch portions 42. The chain stay head portion 41 is connected between the two chain stay branch portions 42 and the bottom bracket 30. Each chain stay branch portion 42 is independently connected to the arc-shaped connection segment 52b of one seat stay branch portion 52 through one rear dropout 60. The longitudinal dimension L1 of each chain stay branch portion 42 is greater than the transverse dimension L2 thereof, and both its longitudinal dimension L1 and transverse dimension L2 gradually decrease from an end thereof adjacent to the bottom bracket 30 to the other end thereof.

The chain stay head portion 41 is configured to connect the chain stay branch portion 42 and the bottom bracket 30. The chain stay branch portion 42 is connected to the arc-shaped connection segment 52b of the seat stay 50 via the rear dropout 60. As described above, the longitudinal dimension L1 of the chain stay branch portion 42 refers to, in a cross-section perpendicular to an extending direction of the chain stay branch portion 42, a dimension of the cross-section in a longitudinal direction thereof, and a transverse dimension L2 of the chain stay branch portion 42 refers to a dimension of the cross-section in a transverse direction thereof.

Since the longitudinal dimension L1 of the chain stay branch 42 is larger than the transverse dimension L2 thereof, the chain stay branch portion 42 is constructed in a structure that is flat from left to right. As such, a space occupied by the chain stay 40 in the left-right direction of the frame 100 is smaller, which can provide more mounting space for a rear wheel, etc. Furthermore, the longitudinal dimension L1 and transverse dimension L2 of the chain stay branch portion 42 both gradually decrease from front to rear, which is conducive to saving material consumption.

Optionally, the two seat stay branch portion 52 are spaced apart in the left-right direction of the frame 100, and the two chain stay branch portions 42 are spaced apart in the left-right direction of the frame 100. A spacing distance between the two seat stay branch portions 52 and a spacing distance between the two chain stay branch portions 42 both gradually increase from an end adjacent to the seat stay head portion 51 to an end adjacent to the rear dropout 60, so as to facilitate mounting of a structure such as the rear wheel, disc brake, and others.

In some embodiments, referring to FIGS. 1 and 2, at least one chain stay branch portion 42 is provided with a disc-brake mounting portion 42a, and the disc-brake mounting portion 42a is disposed adjacent to the rear dropout 60. Specifically, the disc-brake mounting portion 42a includes a plurality of mounting holes, and the disc brake can be mounted in the mounting holes through fasteners. The disc-brake mounting portion 42a can be arranged on one or two chain stay branch portions 42. A position of the disc-brake mounting portion 42a adjacent to the rear dropout 60 is arranged substantially opposite to the arc-shaped connection segment 52b. Thus, mounting space of the disc-brake mounting portion 42a is relatively large.

In some embodiments, referring to FIG. 4, at least one inner wall surface of the chain stay branch portions 42 facing the other one of the chain stay branch portions 42 is provided with an avoiding recess 42b. The avoiding recess 42b is arranged on an end of the chain stay branch portion 42 adjacent to the chain stay head portion 41.

Generally, ends of the two chain stay branch portions 42 adjacent to the chain stay head portion 41 are relatively close to each other. At this time, by providing the avoiding recess 42b on the inner wall surface at a front end of the chain stay branch portion 42, the spacing distance between front ends of the two chain stay branch portions 42 is increased, which facilitates the mounting of the rear wheel.

In some embodiments, referring to FIGS. 1, 2, and 3, the top tube 10 includes a first top tube segment 11, a folding mechanism 13, and a second top tube segment 12. The second top tube segment 12 is connected to the seat tube 20. The first top tube segment 11 is hinged to the second top tube segment 12 through the folding mechanism 13. The folding mechanism 13 allows the first top tube segment 11 to be switched between an unfolded state relative to the second top tube segment and a folded state relative to the second top tube segment.

The first top tube segment 11 is configured to connect to a head tube member 80. The folding mechanism 13 allows the first top tube segment 11 to rotate relative to the second top tube segment 12, thus enabling the first top tube segment 11 to be switched between an unfolded state and a folded state relative to the second top tube segment. A specific structure of the folding mechanism 13 is not specified here, and a person skilled in the art may make it as conventional configurations.

Specifically, when the first top tube segment 11 is in the unfolded state, the first top tube segment 11 is in the same straight line with the second top tube segment 12, thereby enabling the bicycle to be unfolded. When the first top tube segment 11 is in the folded state, the first top tube segment 11 can be arranged side by side with the second top tube segment 12 so as to fold the bicycle. Thus, the frame 100 can be applied to foldable bicycles.

In some embodiments, referring to FIGS. 1 and 2, the frame 100 further includes a tension cable 70. An end of the tension cable 70 is connected to the bottom bracket 30, and the other end thereof is connected to the first top tube segment 11. The tension cable 70 can be, but not limited to, a steel rope. The tension cable 70 is connected between the bottom bracket 30 and the first top tube segment 11. When the first top tube segment 11 is on the unfolded state, the tension cable 70, seat tube 20, and top tube 10 form a triangle, which facilitates to improve stability of the top tube 10 and enhance strength of the frame 100.

Optionally, the frame 100 can be made of metal or carbon fiber materials as a whole.

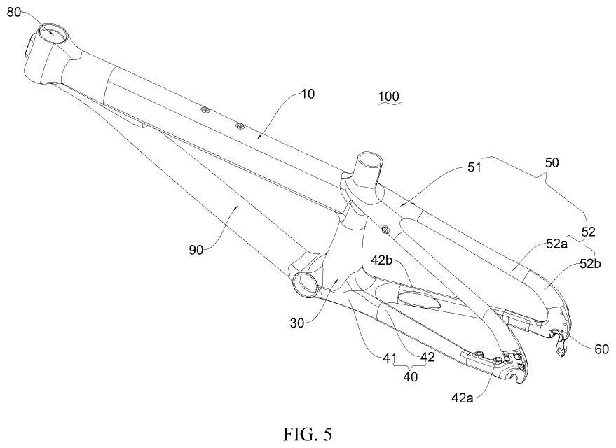

In other embodiments, as shown in FIG. 5, the frame 100 can be of a non-foldable structure, and a reinforcing tube 90 can be used to replace the tension cable 70 or introduced to be connected to the bottom bracket 30 and the top tube 11, so as to reinforce the strength of the frame 100.

In an embodiment of the present application, referring to FIGS. 1 to 4, the frame 100 includes the head tube member 80, top tube 10, seat tube 20, bottom bracket 30, chain stay 40, seat stay 50, rear dropouts 60, and tension cable 70. The top tube 10 includes the first top tube segment 11, folding mechanism 13, and second top tube segment 12. The bottom bracket 30 is connected to the seat tube 20, chain stay 40, and second top tube segment 12. The tension cable 70 is connected to the bottom bracket 30 and first top tube segment 11. The seat stay 50 includes a seat stay head portion 51 and two seat stay branch portions 52. The seat stay head portion 51 is directly connected to the seat tube 20. Each seat stay branch portion 52 includes a transition segment 52a and an arc-shaped connection segment 52b. Each seat stay branch portion 52 is connected to the seat stay head portion 51 through its transition segment 52a. The longitudinal dimension L1 of the seat stay branch portion 52 gradually increases from front to rear, while the transverse dimension L2 of the seat stay branch portion 52 gradually decreases from front to rear. The transverse dimension L2 of each cross-section of the arc-shaped connection segment 52b is less than its longitudinal dimension L1.

In addition, a bicycle is further provided in an embodiment of the present application. The bicycle includes the aforementioned frame 100, and the frame 100 is mainly used as a rear frame of the bicycle. It has all the beneficial effects of the above-mentioned frame 100.

In addition, the frame 100 may include a rear wheel, a front frame, a front wheel, a front end, a seat, and pedals. The rear wheel is mounted on the rear dropouts. The front wheel is mounted on the front frame. The front frame is mounted on the head tube member 80 through the front end. The seat is mounted on the seat tube 20. The pedals are mounted on the bottom bracket 30.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

The foregoing descriptions are merely specific embodiments of the present invention, but are not intended to limit the protection scope of the present invention. Any variation or replacement readily figured out by a person skilled in the art within the technical scope disclosed in the present invention shall all fall within the protection scope of the present invention. Therefore, the protection scope of the present invention shall be subject to the protection scope of the appended claims.

What is claimed is:

1. A frame, comprising a seat stay, the seat stay comprising a seat stay head portion and a seat stay branch portion, the seat stay branch portion comprising a transition segment and an arc-shaped connection segment that are adjacently disposed in a front-rear direction of the frame, and the transition segment and the seat stay head portion being adjacently disposed;
wherein a minimum longitudinal dimension of the arc-shaped connection segment is more than 1.5 times of a minimum longitudinal dimension of the transition segment, and a length of the seat stay branch portion accounts for more than 25% of a total length of the seat stay;
wherein a longitudinal dimension refers to, in any cross-section perpendicular to an extending direction of the seat stay, a dimension of a cross-section in a longitudinal direction thereof, and a longitudinal direction of the cross-section is perpendicular to an orthographic projection of a left-right direction of the frame on the cross-section.

2. The frame according to claim 1, wherein a longitudinal dimension of the arc-shaped connection segment gradually increases from an end thereof adjacent to the transition segment to another end thereof.

3. The frame according to claim 2, wherein in any cross-section of the arc-shaped connection segment, a transverse dimension of the arc-shaped connection segment is less than the longitudinal dimension of the arc-shaped connection segment;
wherein the transverse dimension refers to a dimension of the cross-section in a transverse direction thereof, and the transverse direction of the cross-section is consistent with the orthographic projection of the left-right direction of the frame on the cross-section.

4. The frame according to claim 1, wherein the longitudinal dimension of the transition segment gradually increases from an end thereof adjacent to the seat stay head portion to another end thereof adjacent to the arc-shaped connection segment.

5. The frame according to claim 1, wherein a transverse dimension of the seat stay branch portion gradually decreases from an end thereof adjacent to the seat stay head portion to another end thereof.

6. The frame according to claim 1, wherein a longitudinal dimension of the seat stay head portion is less than a transverse dimension of the seat stay head portion.

7. The frame according to claim 1, further comprising a top tube, a seat tube, a bottom bracket, a chain stay, and two rear dropouts;
wherein the seat tube is connected to the top tube and the seat stay head portion, the bottom bracket is connected to the seat tube and the chain stay, each rear dropout is connected to the arc-shaped connection segment and the chain stay, and the arc-shaped connection segment is arched away from the chain stay.

8. The frame according to claim 7, wherein the chain stay comprises a chain stay head portion and two chain stay branch portions, the chain stay head portion is connected between the two chain stay branch portions and the bottom bracket, each chain stay branch portion is independently connected to the arc-shaped connection segment of one seat stay branch portion through the rear dropout, a longitudinal dimension of each chain stay branch portion is greater than a transverse dimension of the chain stay branch portion, and both the longitudinal dimension and transverse dimension of the chain stay branch portion gradually decreases from an end thereof adjacent to the bottom bracket to another end thereof.

9. The frame according to claim 8, wherein at least one of the chain stay branch portions is provided with a disc-brake mounting portion disposed adjacent to the rear dropout.

10. The frame according to claim 8, wherein an inner wall surface of the at least one of the chain stay branch portions facing another one of the chain stay branch portions is provided with an avoiding recess, and the avoiding recess is arranged on an end of the chain stay branch portion adjacent to the chain stay head portion.

11. The frame according to claim 7, wherein the top tube comprises a first top tube segment, a folding mechanism, and a second top tube segment, the second top tube segment is connected to the seat tube, the first top tube segment is hinged to the second top tube segment via the folding mechanism, and the folding mechanism allows the first top tube segment to be switched between an unfolded state relative to the second top tube segment and a folded state relative to the second top tube segment.

12. The frame according to claim 7, further comprising a tension cable, wherein one end of the tension cable is connected to the bottom bracket, and another end of the tension cable is connected to the first top tube segment.

13. A bicycle, comprising the frame according to claim 1.
